(19) United States
(12) Patent Application Publication
(10) Pub. No.: US 2013/0170193 A1
(43) Pub. Date: Jul. 4, 2013

(54) IMAGE DISPLAY DEVICE

(71) Applicants: Tsuyoshi Shigeta, Moriguchi City (JP); Masaya Nakamichi, Moriguchi City (JP)

(72) Inventors: Tsuyoshi Shigeta, Moriguchi City (JP); Masaya Nakamichi, Moriguchi City (JP)

(73) Assignee: SANYO ELECTRIC CO., LTD., Moriguchi City, Osaka (JP)

(21) Appl. No.: 13/823,541

(22) PCT Filed: Oct. 26, 2011
(86) PCT No.: PCT/JP2011/074613

§ 371 Date: Mar. 14, 2013

(30) Foreign Application Priority Data
Nov. 30, 2010 (JP) 2010-266333
Nov. 30, 2010 (JP) 2010-266352

(51) Int. Cl. F21L 4/08

(52) U.S. Cl. CPC F21L 4/08
USPC 362/183

(57) ABSTRACT

Disclosed is an image display device, which is provided with an optical power generating section, which generates power when light is applied, a display section, which displays an image using the power obtained by the power generation performed by the optical power generating section, and a body section having the display section provided therein. The optical power generating section is provided vertically above the body section.

### TECHNICAL FIELD

The present invention relates to image display devices for displaying images.

### BACKGROUND ART

Today, image display devices such as LCD displays are used in digital signage applications. In this connection, for example, Patent Document 1 discloses an image display device provided with, to cope with installation outdoors, a hermetic structure for preventing entry of water and dust and a cooling structure for suppressing a rise in temperature.

On the other hand, Patent Document 2 discloses an image display device that is driven with electric power obtained through power generation by a solar cell. Patent Document 2 discloses, in FIG. 1, a solar cell provided on a side face of the base on which the image display device is installed, and a light admitting device for efficient irradiation of the solar cell with light.

### LIST OF CITATIONS

### Patent Literature

Patent Document 1: Japanese Patent Application Publication No. 2009-294284
Patent Document 2: Japanese Patent Application Publication No. 2005-321738

### SUMMARY OF THE INVENTION

### Technical Problem

Inconveniently, the image display device disclosed in Patent Document 2 requires separate installation of the light admitting device. Moreover, in a case where electric power needs to be supplied to a large display device and the solar cell needs to be accordingly large, a large installation area is required. Moreover, the light admitting device and the solar cell need to be installed in a particular positional relationship with respect to the sun, and this diminishes flexibility in installation.

### Solution to the Problem

According to one aspect of the invention, an image display device is provided with:

a photovoltaic power generation portion which generates electric power when irradiated with light;

a display portion which displays an image by using the electric power obtained through power generation by the photovoltaic power generation portion; and

a body portion which is provided with a display portion, wherein

the photovoltaic power generation portion is provided vertically over the body portion.

According to another aspect of the invention, an image display device is provided with:

a photovoltaic power generation portion which generates electric power when irradiated with light;

a display portion which displays an image by using the electric power obtained through power generation by the photovoltaic power generation portion; and

a body portion which is provided with a display portion, wherein

the photovoltaic power generation portion is provided vertically over the body portion and can take a plurality of rotated states.

### BRIEF DESCRIPTION OF DRAWINGS

FIG. 1 is a front perspective view of an image display device 1;

FIG. 2 is a rear perspective view of the image display device 1;

FIG. 3 is a side view of the image display device 1;

FIG. 4 is a front perspective view of an image display device 100;

FIG. 5 is a rear perspective view of the image display device 100;

FIG. 6 is a side view of the image display device 100;

FIG. 7 is a plan view showing a flat plate member 131 of a support portion 130 provided in the image display device 100;

FIG. 8 is a rear perspective view showing another example of how the photovoltaic power generation portion is fitted in the image display device 100;

FIG. 9 is a front perspective view of an image display device 200;

FIG. 10 is a rear perspective view of the image display device 200;

FIG. 11 is a side view of the image display device 200;

FIG. 12 is a rear perspective view showing another example of how the photovoltaic power generation portion is fitted in the image display device 200;

FIG. 13 is a rear perspective view of an image display device 300;

FIG. 14 is a rear perspective view showing another example of how the photovoltaic power generation portion is fitted in the image display device 300;

FIG. 15 is a rear perspective view of an image display device 400;

FIG. 16 is a side view of the image display device 400; and

FIG. 17 is a rear perspective view showing another example of how the photovoltaic power generation portion is fitted in the image display device 400.

### DESCRIPTION OF EMBODIMENTS

Embodiments of the present invention will be described below with reference to the accompanying drawings.

### Embodiment 1

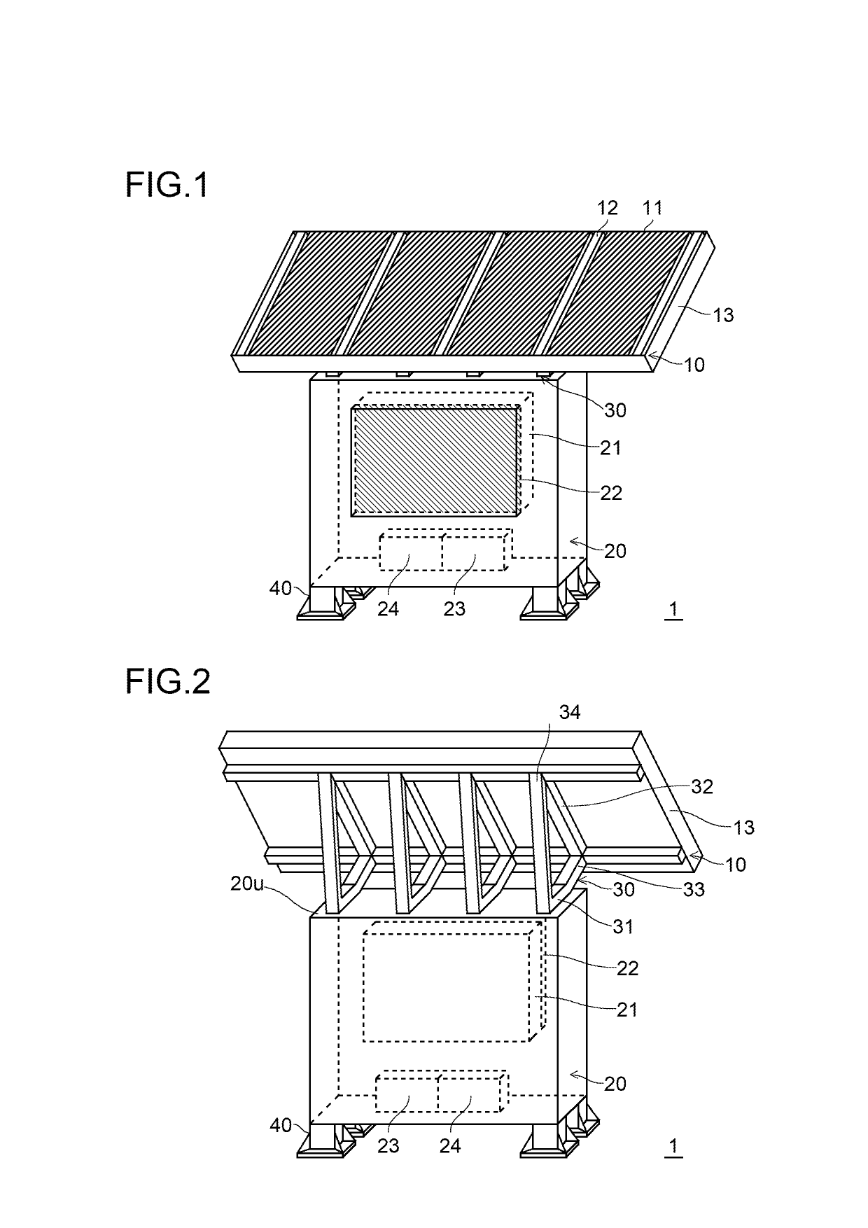

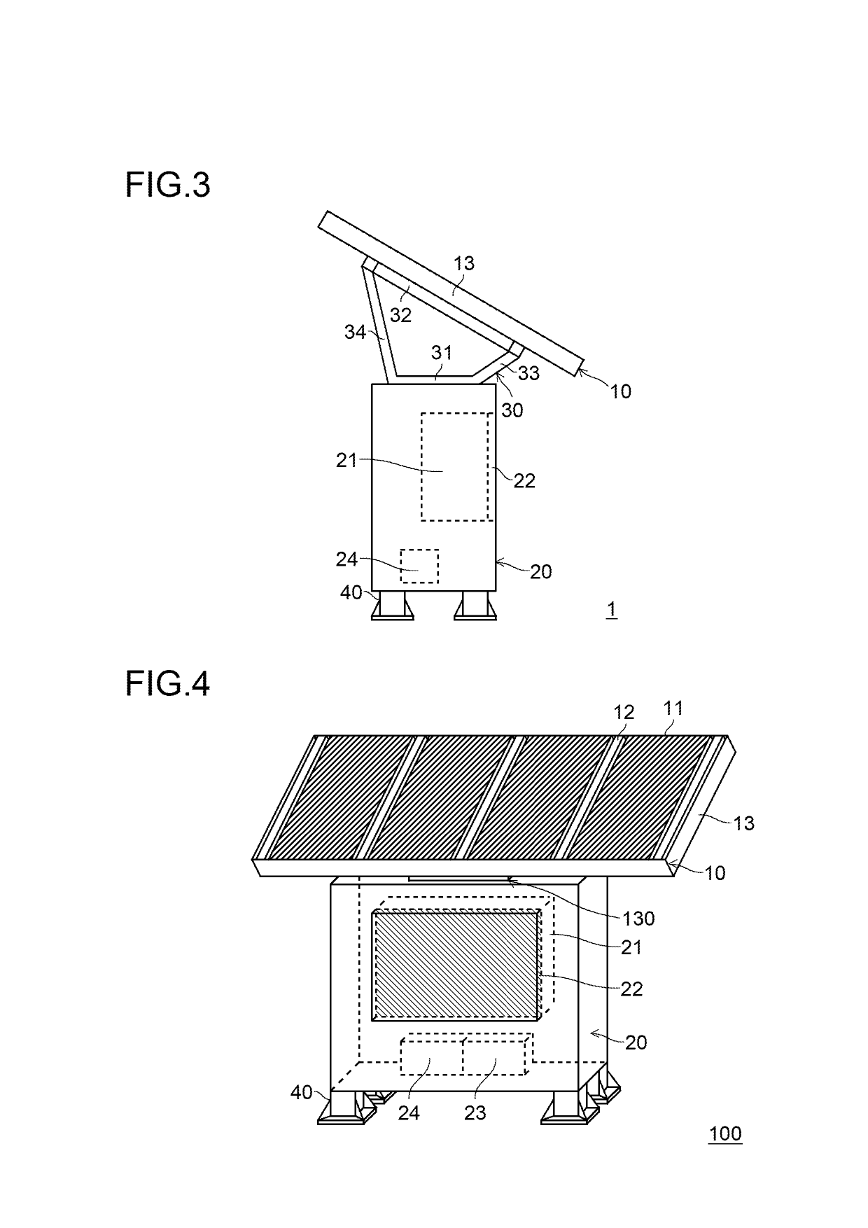

First, an image display device 1 according to a first embodiment of the invention will be described with reference to the relevant drawings. FIG. 1 is a front perspective view of the image display device 1, and FIG. 2 is a rear perspective view of the image display device 1. FIG. 3 is a side view of the image display device 1.

As shown in FIGS. 1 to 3, the image display device 1 is provided with a photovoltaic power generation portion 10, a body portion 20 in the shape of a rectangular parallelepiped, support portions 30 arranged on the top face of the body portion 20 to support the photovoltaic power generation portion 10, and leg portions 40 provided in four corners on the bottom face of the body portion 20 to support the image display device 1.

The photovoltaic power generation portion 10 is provided with four photovoltaic panels 11 which convert the energy of the light with which they are irradiated into electric power, a mounting base 13 in the shape of a flat plate on which the photovoltaic panels 11 are arranged, and fixing portions 12 provided on the mounting base 13 to fix the photovoltaic panels 11.

The fixing portions 12 are fixed to the mounting base 13 with bolts and nuts or the like. The photovoltaic panels 11 have their edge parts pressed against the mounting base 13 by the fixing portions 12, and are thereby fixed to it.

The body portion 20 is provided with a display portion 21 which displays an image, a window portion 22 provided in the front face of the body portion 20 to make the display portion 21 visible, a rechargeable battery 23 which is charged with electric power supplied from the photovoltaic power generation portion 10 and which supplies electric power to the display portion 21 etc., and a control device 24 which controls, among others, the charging of the rechargeable battery 23. The body portion 20 may be further provided with, though not shown, a fan or the like for cooling the inside of the body portion 20.

The display portion 21 includes, for example, an LCD panel or the like, and is driven with the electric power obtained in the photovoltaic power generation portion 10. The window portion 22 includes a transparent member, such as a sheet of glass, and is provided for the purpose of protecting the LCD panel from external impact, water, dust, etc. The display portion 21 may be provided with a touch panel on the front face side.

The rechargeable battery 23 is charged with the electric power obtained in the photovoltaic power generation portion 10. For example, the rechargeable battery 23 is charged with, of the electric power generated, the part that is not consumed by the image display device 1. On the other hand, when the photovoltaic power generation portion 10 is not generating electric power as during the night or under cloudy weather, the rechargeable battery 23 discharges as necessary to supply electric power to the image display device 1.

The support portions 30 are arranged on the top face 20u of the body portion 20 and support the photovoltaic power generation portion 10. With consideration given to the incident angle of the sunlight, the support portions 30 are so formed that the surface of the photovoltaic power generation portion 10 has a predetermined angle relative to the top face 20u of the body portion 20.

As shown in FIG. 2 etc., the support portions 30 are each provided with a first member 31, a second member 32, a third member 33, and a fourth member 34, each of which is a beam-shaped member. Four sets of such members, that is, four support potions 30 are provided on top of the body portion 20. The first members 31 are fixed to the top face 20u of the body portion 20. The second members 32 are fixed to the back face of the mounting base 13. The third members 33 connect together the lower ends of the first and second members 31 and 32. The fourth members 34 connect together the upper ends of the first and second members 31 and 32. The first, second, third, and fourth support members 31, 32, 33, and 34 are each beam-shaped.

The first, second, third, and fourth support members 31, 32, 33, and 34 that constitute one set are located approximately on the same plane (a plane perpendicular to the top face of the body portion 20).

As described above, in the image display device 1, the photovoltaic power generation portion 10 which is large to serve the purpose of driving the display device is arranged over the body portion 20. This helps reduce the installation area of the image display device 1 and improve flexibility in installation.

On the other hand, the rechargeable battery 23 and the control device 24 are provided under the display portion 21. This permits the display portion 21 to be arranged about the height of the human eye, making it easily viewable. In addition, the rechargeable battery 23 and the control device 24 can then be arranged in the vacant space left perpendicularly under the display portion 21. The image display device 1 may instead be configured without leg portions 40 so that the body portion 20 is installed on the ground. How the photovoltaic panels 11 are arranged and fixed here is merely one example, and may be implemented in any other manner. Although four support portions 30 are used in the above example, the number of sets is not limited to four.

### Embodiment 2

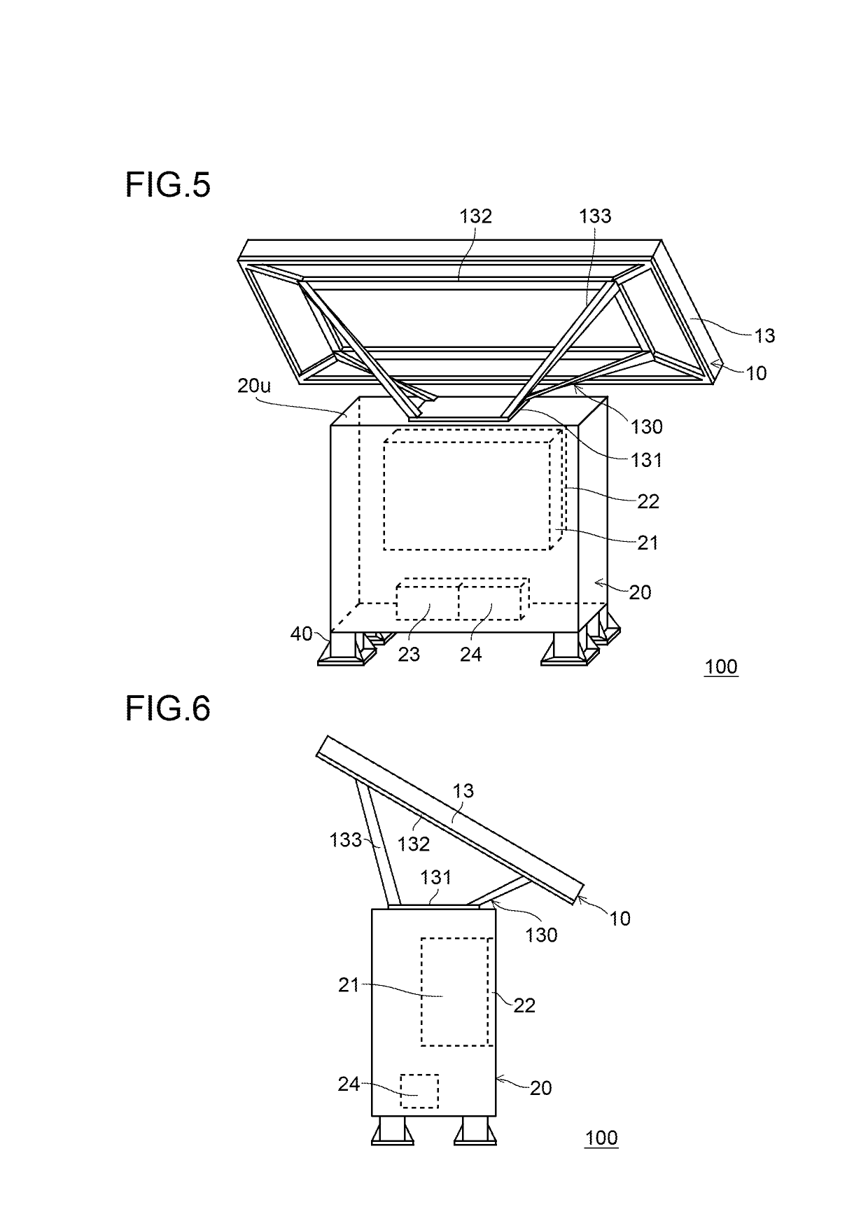

Next, an image display device 100 according to a second embodiment of the invention will be described with reference to the relevant drawings. FIG. 4 is a front perspective view, FIG. 5 is a rear perspective view, and FIG. 6 is a side view.

The image display device 100 of this embodiment, as compared with the image display device of the first embodiment, has a differently structured support portion 130.

The support portion 130 is provided with one flat plate member 131, four beam-shaped members 132, and four column members 133. The flat plate member 131 is a member in the shape of a flat plate which is fixed to the top face 20u of the body portion 20. The beam-shaped members 132 are fixed to the back face of the mounting base 13 of the photovoltaic power generation portion 10 such that each beam-shaped member 132 forms one side of a rectangular that is geometrically similar to the photovoltaic power generation portion 10. The column members 133 connect parts of the flat plate member 131 near its four corners to the vertices of the just-mentioned rectangular. Here, the column members 133 are connected together in such a combination that the distances between the four corners of the flat plate member 131 and the four corners of the beam-shaped members 132 are shortest.

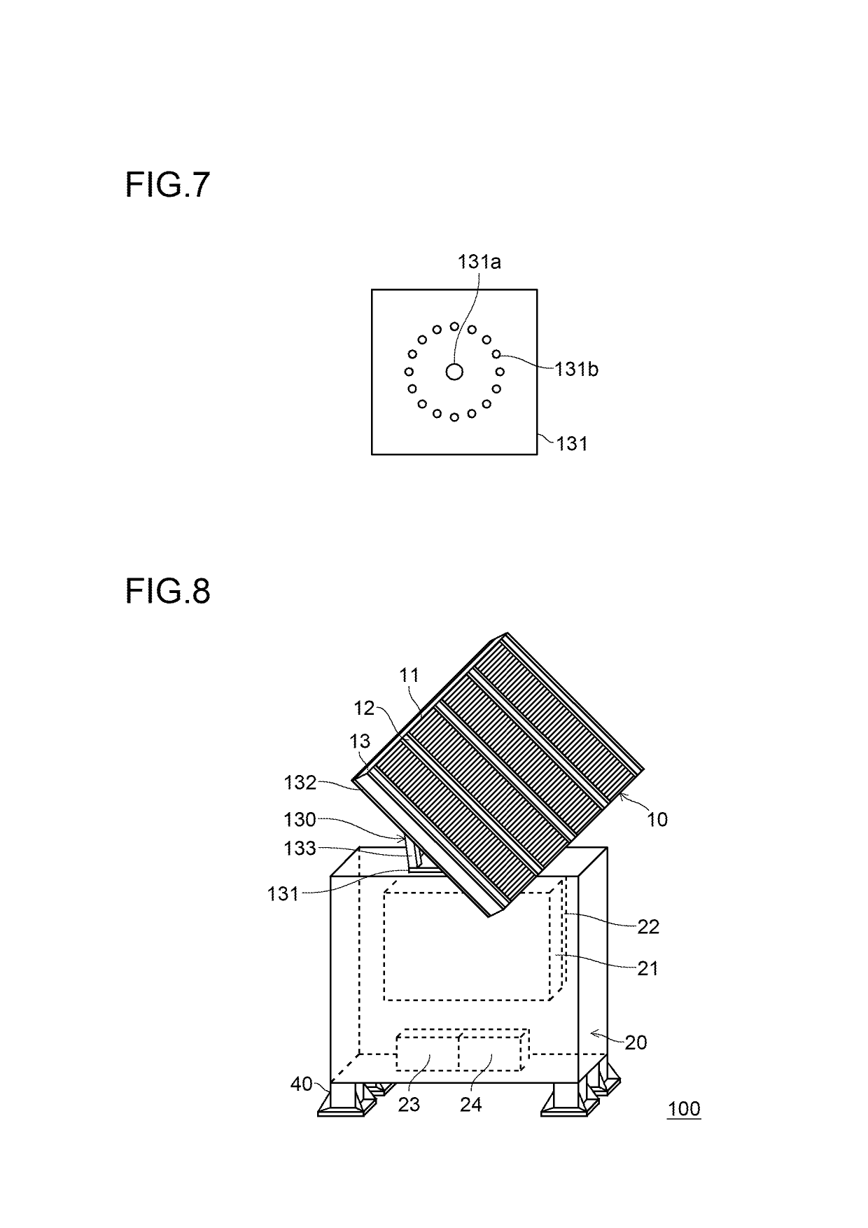

FIG. 7 is a plan view showing a bottom face part of the support portion 130.

At the center of the flat plate member 131, a guide hole 131a is provided. Moreover, 16 fitting holes 131b are provided in a concentric arrangement about the guide hole 131a as the center.

In the top face 20u of the body portion 20, a threaded hole c is provided, and by putting a screw through this threaded hole c and the guide hole 131a, the support portion 130 can be kept in fixed position on the top face 20u.

Moreover, in the top face 20u, 16 threaded holes p are provided in a concentric arrangement around the threaded hole c. Thus, by rotating the support portion 130 about the guide hole 131a as the center, and putting screws through the 16 fitting holes 131b and the 16 threaded holes p respectively, it is possible to set the installation orientation of the support portion 130. In this way, it is possible to change the orientation of the photovoltaic power generation portion 10 alone, without changing the orientation of the body of the image display device 1. For example, by changing the direction of the flat plate member 131 through 90 degrees, it is possible to arrange the photovoltaic power generation portion 10 in a direction as shown in FIG. 8.

The arrangement of the guide holes 131a and the fitting holes 131b in the flat plate member 131 may be other than as shown in FIG. 7.

### Embodiment 3

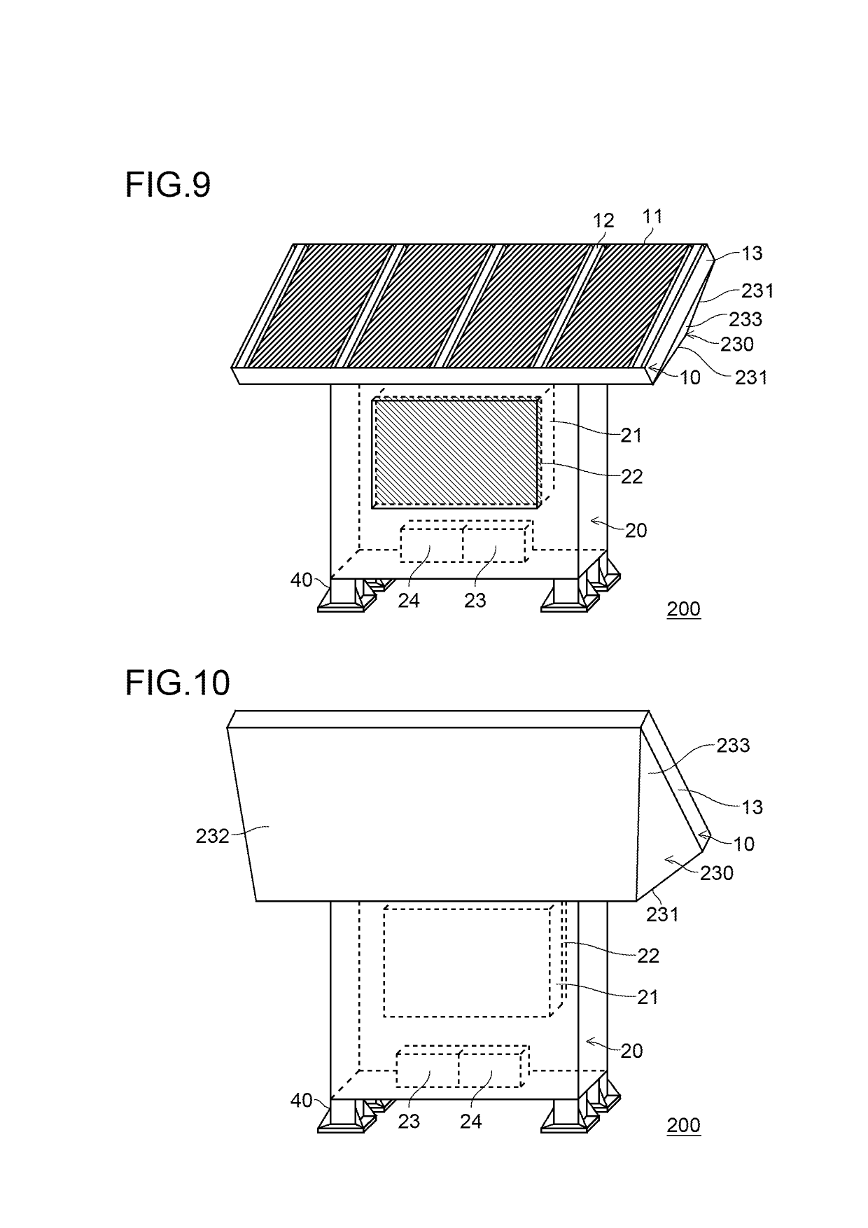

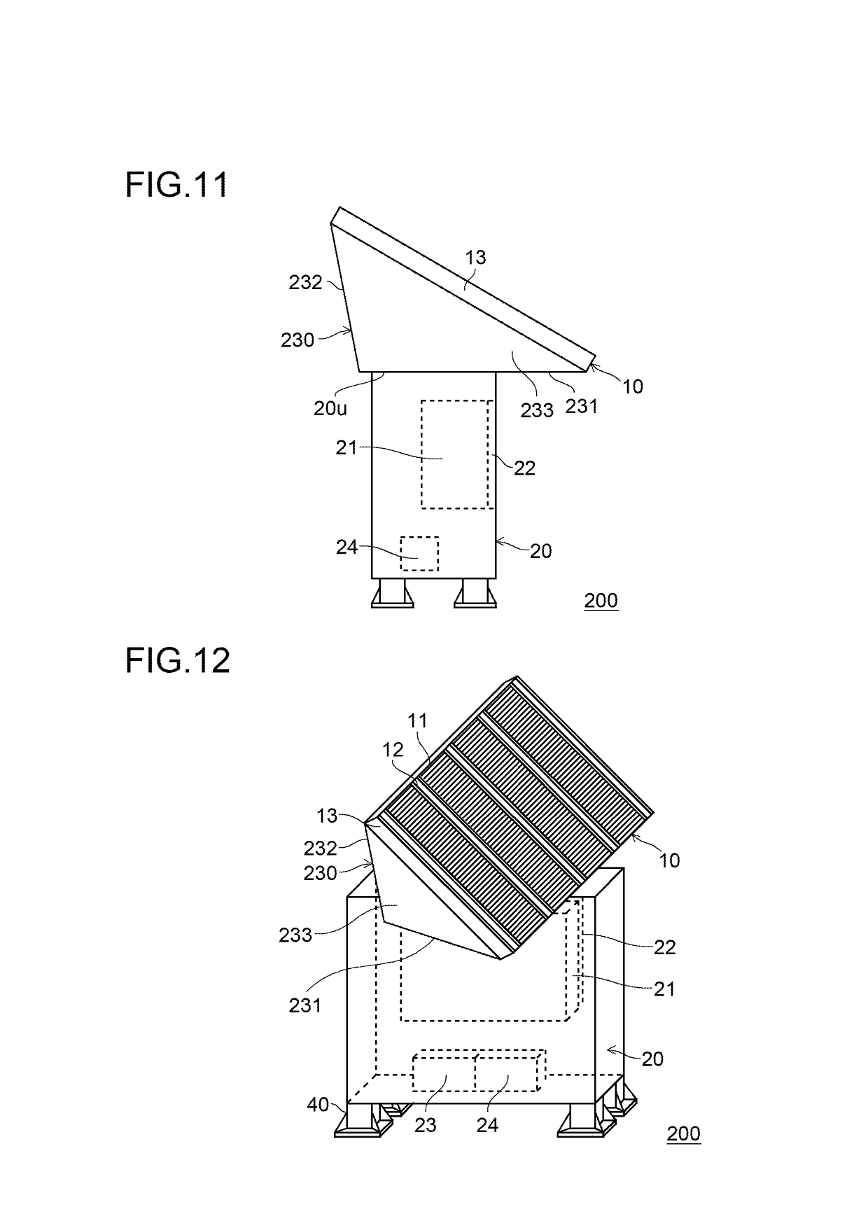

Next, an image display device 200 according to a third embodiment of the invention will be described with reference to the relevant drawings. FIG. 9 is a front perspective view, FIG. 10 is a rear perspective view, and FIG. 11 is a side view.

The image display device 200, as compared with the image display device 1 of the first embodiment described previously, has a differently structured support portion 230. The following description is focused on the support portion 230.

As shown in FIGS. 9 to 11, the support portion 230 is provided with a bottom face 231, one back face 232, and two side faces 233.

The bottom face 231 has a rectangular shape with four sides, and is fixed to the top face 20u of the body portion 20. One of the four sides makes contact, over its entire length, with the back face of the photovoltaic power generation portion 10. The back face 232 also has a rectangular shape with four sides, with the top side making contact, over its entire length, with the back face of the photovoltaic power generation portion 10 and the bottom side making contact, over its entire length, with the bottom face 231. The two side faces 233 each have a triangular shape surrounded by the back face of the photovoltaic power generation portion 10, the bottom face 231, and the back face 232.

The support portion 230 (the bottom face portion 231, the back face portion 232, and the side face portions 233) and the photovoltaic power generation portion 10 together form a pentahedron as a whole.

As in the second embodiment (FIG. 7), by providing in the bottom face 231 one guide hole and a plurality of fitting holes in a concentric arrangement about it as the center, it is possible to fix the body portion 20 to the top face, and to change the fitting orientation of the bottom face 231. In this embodiment, however, for structural reasons, fixing using screws cannot be done from above as in the image display device 100; fixing can instead be achieved by putting screws through the threaded holes, the guide holes, etc. in the top face 20u from inside the body portion 20. Instead of providing threaded holes in the top face 20u, projections may be formed on the top face 20u so that fixing can be achieved by fitting guide holes or the like around those projections.

Also in, for example, the image display device 200, as shown in a rear perspective view in FIG. 12, the photovoltaic power generation portion 10 can be fixed to the top face of the body portion 20 with the orientation of the former changed through 90 degrees relative to the example shown in FIG. 9 etc.

In the image display device 200, the support portion 230 has a structure where a combination of flat plate members and the photovoltaic power generation portion 10 together form a polyhedron. This makes it possible to reduce the effect of wind (air flow), such as wind noise and wind pressure, through regulation of air flow.

### Embodiment 4

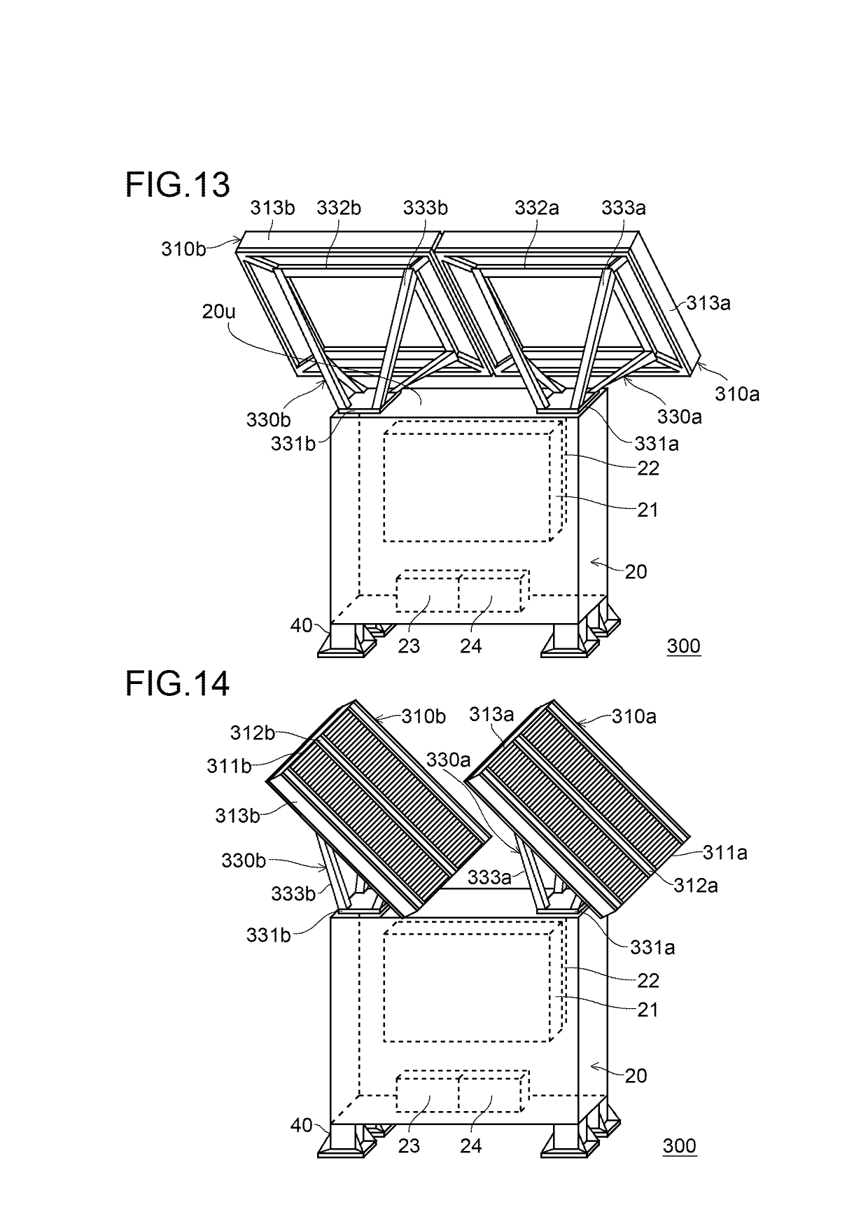

Next, an image display device 300 according to a fourth embodiment of the invention will be described with reference to the relevant drawings. FIG. 13 is a rear perspective view of the image display device 300.

As shown in FIG. 13, the image display device 300 is provided with a photovoltaic power generation portion 310a, a support portion 330a which supports it, a photovoltaic power generation portion 310b, and a support portion 330b which supports it. The support portions 330a and 330b are each arranged on the top face 20u of the body portion 20. That is, a difference from the image display device 100 of the second embodiment is the provision of a plurality of photovoltaic power generation portions and a plurality of support portions.

The photovoltaic power generation portion 310a is provided with two photovoltaic panels 311a, a mounting base 313a on which those photovoltaic panels are arranged, and fixing portions 312a which are provided on the mounting base 313a to fix the photovoltaic panels. Likewise, the photovoltaic power generation portion 310b is provided with two photovoltaic panels 311b, a mounting base 313b, and fixing portions 312b). Like the support portion 130 in the second embodiment, the support portion 330a is provided with one flat plate member 331a, four beam-shaped members 332a, and four column members 333a. Likewise, the support portion 330b is provided with one flat plate member 331b, four beam-shaped members 332b, and four column members 333b.

In the flat plate members 331a and 331b, as in the one shown in FIG. 7, guide holes and fitting holes are provided. This makes it possible to change the orientation of the photovoltaic power generation portions 310a and 310b.

For example, as shown in FIG. 14, each photovoltaic power generation portion can be fixed with its orientation changed through 90 degrees. In the example of the second embodiment, the four photovoltaic panels are put together into a single unit, resulting in a structure where changing the direction of the photovoltaic power generation portion causes it to protrude from the body of the image display device. By contrast, in this embodiment, since the photovoltaic power generation portions are divided into two parts, changing their direction does not cause them to protrude from the body of the image display device. This helps achieve space saving.

The photovoltaic power generation portion and the support portion in the image display device 200 of the third embodiment may each be divided into two parts to obtain a structure similar to that of this embodiment.

### Embodiment 5

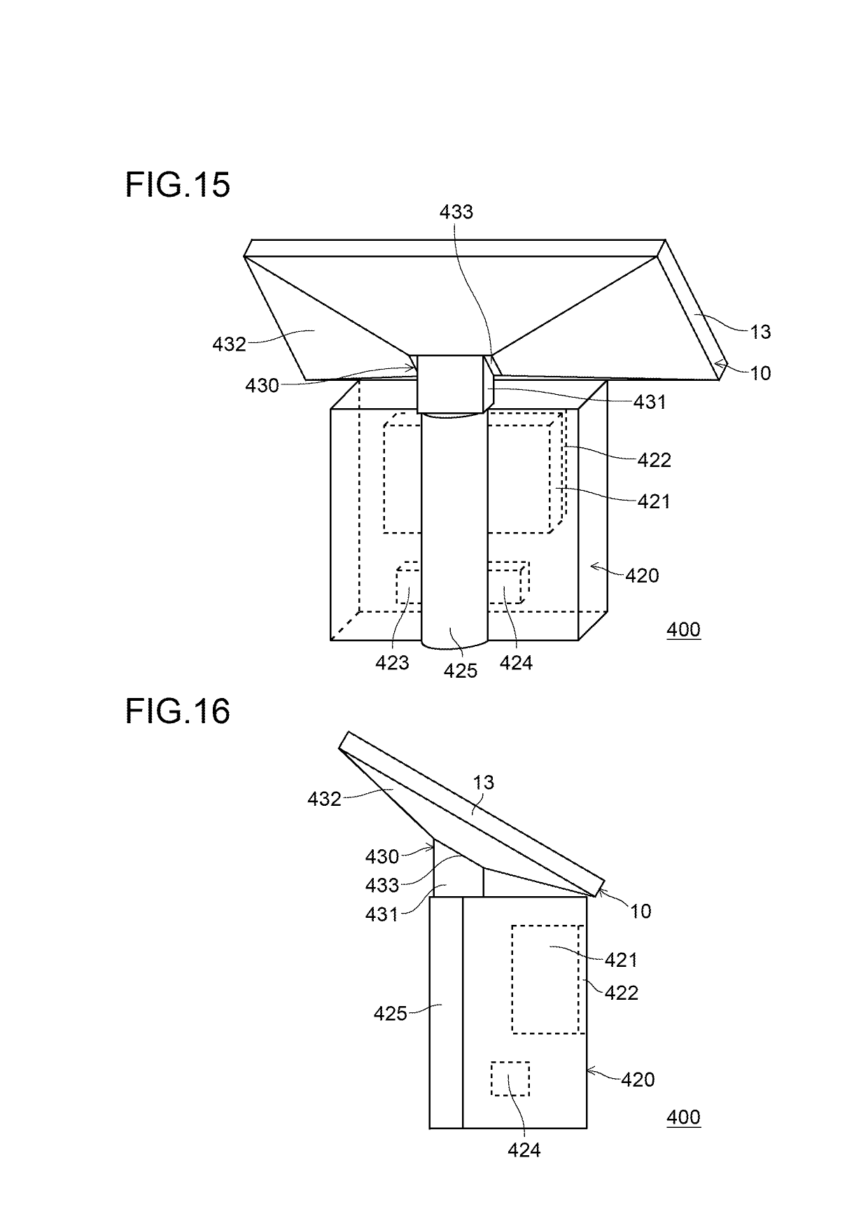

Next, an image display device 400 according to a fifth embodiment of the invention will be described with reference to the relevant drawings. FIGS. 15 and 16 are a rear perspective view and a side view, respectively, of the image display device 400.

As shown in FIG. 15, the image display device 400 is provided with a photovoltaic power generation portion 10, a body portion 420, and a support portion 430. The body portion 420 is provided with a display portion 421, a window portion 422, a rechargeable battery 423, a control device 424, and a column portion 425. In this embodiment, the provision of the column portion 425 is a difference from the image display device 200 of the third embodiment.

The column portion 425 is a column-shaped member with an approximately semicircular cross section. The column portion 425 is arranged on the back face side of the body portion 420. As shown also in FIG. 16, the top face of the column portion 425 is located at approximately the same height as the top face of the body portion 420. The bottom face of the column portion 425 is located at approximately the same height as the bottom face of the body portion 420. For stable installation of the image display device 400, a bottom part of the column portion 425 may be buried in the ground.

Back in FIG. 15, the support portion 430 which supports the photovoltaic power generation portion is provided with a column portion 431, side face portions 432, and a bottom portion 433. The column portion 431 is a hexahedral, columnar member, of which the top face, the bottom face, the front face (these three faces are hidden and not shown in FIG. 15), and the back face are rectangular and the two side faces are trapezoid. The rear face is larger than the front face. That is, the column portion 431 has its top face inclined relative to its bottom face. The bottom face of the column portion 431 is arranged so as to sit on the top face of the body portion 420. On the top face of the column portion 431, the bottom portion 433 is arranged so as to sit on it. This makes it possible to support the photovoltaic power generation portion with an inclination angle relative to the ground.

The side face portions 432 are divided into four faces, which along with the bottom portion 433 and the back face of the photovoltaic power generation portion form a quadrangular pyramid.

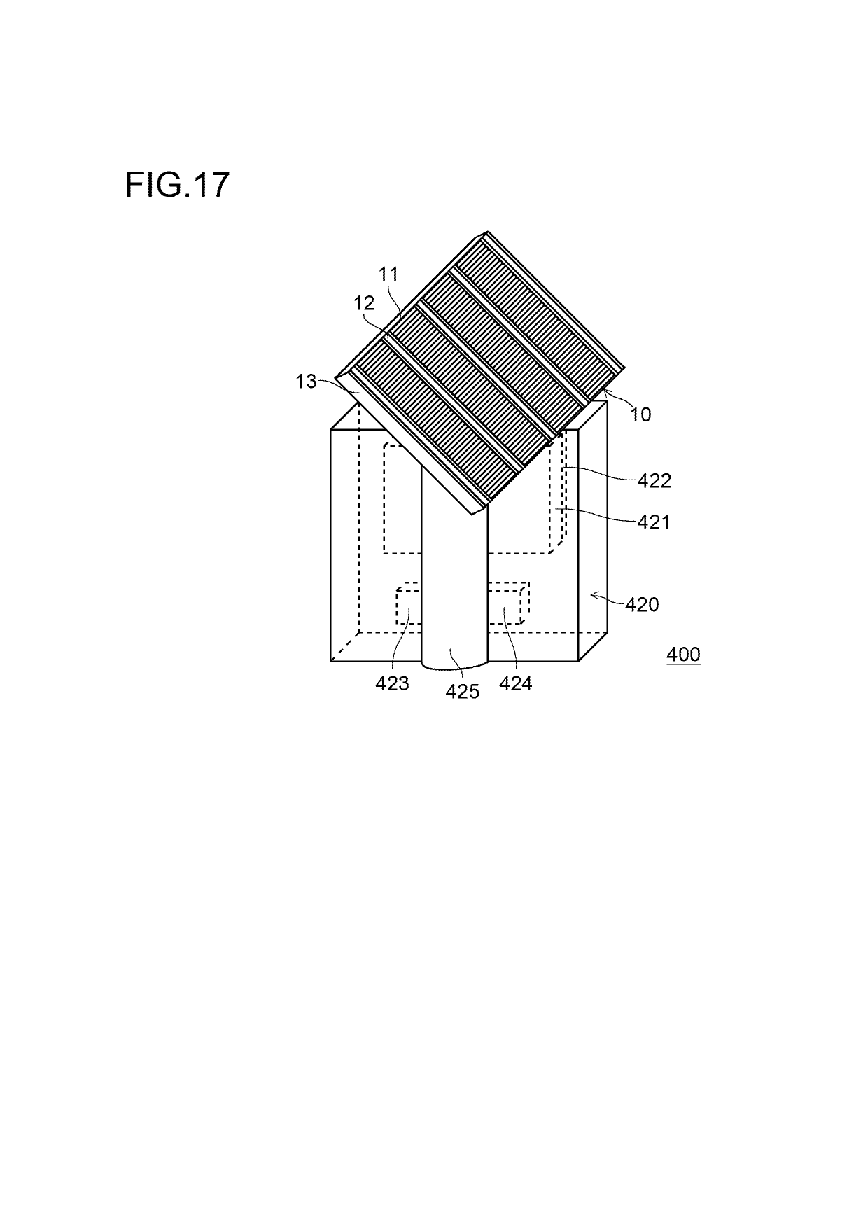

By providing in the bottom face of the column portion 431a guide hole, fitting holes in a concentric arrangement, etc. as shown in FIG. 7 directed to the second embodiment, and providing corresponding threaded holes in the top face of the column portion 425, it is possible to fix the column portion 431 to the top face of the body portion 420, and to change its orientation (FIG. 17).

The support portion 430 may be rotated dynamically. For example, the support portion 430 may be rotated in such a way that the surface of the photovoltaic power generation portion 10 points as close as possible in the direction of the sun all the time.

### Modified Examples

The image display device may be given any shape other than the shape of a rectangular parallelepiped.

The embodiments by way of which the present invention has been described above are in no way meant to limit the scope of the invention; many modifications and variations are possible within the spirit of the invention.

1: An image display device comprising:
a photovoltaic power generation portion which generates electric power when irradiated with light;
a display portion which displays an image by using the electric power obtained through power generation by the photovoltaic power generation portion; and
a body portion which is provided with a display portion, wherein
the photovoltaic power generation portion is provided vertically over the body portion.

2: The image display device according to claim 1, further comprising a support portion which is provided on a top face of the body portion and which supports the photovoltaic power generation portion, which is approximately flat-plate-shaped, in a state inclined relative to a horizontal plane.

3: The image display device according to claim 1, further comprising a support portion which is provided on a top face of the body portion and which supports the photovoltaic power generation portion, which is approximately flat-plate-shaped, at a predetermined angle relative to a horizontal plane, wherein
the angle of the photovoltaic power generation portion relative to the horizontal plane is an angle corresponding to a latitude of a region where the image display device is intended to be installed.

4: The image display device according to claim 1, wherein
a vertically projected area of the body portion is smaller than a vertically projected area of the photovoltaic power generation portion.

5: The image display device according to claim 4, wherein
a vertically projected shadow of the body portion lies within a vertically projected shadow of the photovoltaic power generation portion.

6: The image display device according to claim 1, further comprising a power storage portion which is charged with the electric power obtained through power generation by the photovoltaic power generation portion and which discharges to supply electric power to the image display device, wherein
the power storage portion is provided vertically under the display portion.

7: An image display device comprising:
a photovoltaic power generation portion which generates electric power when irradiated with light;
a display portion which displays an image by using the electric power obtained through power generation by the photovoltaic power generation portion; and
a body portion which is provided with a display portion, wherein
the photovoltaic power generation portion is provided vertically over the body portion and can take a plurality of rotated states.

8: The image display device according to claim 7, further comprising a support portion which supports the photovoltaic power generation portion, which is approximately flat-plate-shaped, in a state inclined relative to a horizontal plane, wherein
a top face of the body portion and a bottom face of the support portion are fixed together with a fitting member, and
in at least one of the top face of the body portion and the bottom face of the support portion, positions where the fitting member can be fitted are rotation-symmetrically located.

9: The image display device according to claim 7, further comprising a support portion which supports the photovoltaic power generation portion, which is approximately flat-plate-shaped, in a state inclined relative to a horizontal plane, wherein
the support portion is rotatably supported on a top face of the body portion.

10: The image display device according to claim 8, wherein
the support portion has a structure composed of a combination of beam-shaped members.

11: The image display device according to claim 9, wherein
the support portion has a structure composed of a combination of beam-shaped members.

12: The image display device according to claim 8, wherein
the support portion has a structure composed of a combination of flat-plate-shaped members which, along with the photovoltaic power generation portion, forms a polyhedron.

13: The image display device according to claim 9, wherein
the support portion has a structure composed of a combination of flat-plate-shaped members which, along with the photovoltaic power generation portion, forms a polyhedron.

14: The image display device according to claim 7, wherein a plurality of support portions and a plurality of photovoltaic power generation portions are provided on a top face of the body portion.
